(19) United States
(12) Patent Application Publication
(10) Pub. No.: US 2026/0320070 A1
(43) Pub. Date: Oct. 15, 2026

(54) AGENT REPLICATION WITH LOCAL CONTEXT INFORMATION AND DATA SEGMENTATION

(71) Applicant: Salesforce, Inc., San Francisco, CA (US)

(72) Inventors: Jose Lejin P J, Bangalore (IN); Ratheesh Krishna Vadhyar, Bangalore (IN)

(21) Appl. No.: 19/176,073

(22) Filed: Apr. 10, 2025

(51) Int. Cl. G06F 16/27

(52) U.S. Cl. CPC G06F 16/27

(57) ABSTRACT

A system may perform initial communications with a first user through multiple first agents of an artificial intelligence (AI) platform that have access to global context information. The system may generate a replica instance of at least one platform agent based on receiving one or more queries from the first user during initial communications. The system may conduct subsequent communications with the first user via secondary agents that include the replica instance, which maintains both global context information and user-specific local context information. The system may destroy the replica instance and its associated user-specific local context information after completing the subsequent communications. In some examples, the first agents may capture information later categorized as sensitive. The information may be encrypted, removed from the first agent, and transferred to the replica agent for subsequent operations.

### FIELD OF TECHNOLOGY

The present disclosure relates generally to database systems and data processing, and more specifically to agent replication with local context information and data segmentation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may employ the use of an artificial intelligence (AI) platform. However, such methods may be improved.

### BRIEF DESCRIPTION OF THE DRAWINGS

FIG. 1 illustrates an example of a data processing at an AI platform system that supports agent replication with local context information and data segmentation in accordance with examples as disclosed herein.

FIG. 2 shows an example of a system that supports agent replication with local context information and data segmentation in accordance with examples as disclosed herein.

FIG. 3 shows an example of a process flow that supports agent replication with local context information and data segmentation in accordance with examples as disclosed herein.

FIG. 4 shows a block diagram of an apparatus that supports agent replication with local context information and data segmentation in accordance with examples as disclosed herein.

FIG. 5 shows a block diagram of an agent replication manager that supports agent replication with local context information and data segmentation in accordance with examples as disclosed herein.

FIG. 6 shows a diagram of a system including a device that supports agent replication with local context information and data segmentation in accordance with examples as disclosed herein.

FIG. 7 shows a flowchart illustrating methods that support agent replication with local context information and data segmentation in accordance with examples as disclosed herein.

### DETAILED DESCRIPTION

Artificial intelligence (AI) platforms may use agents (e.g., AI agents) to interact with users. For example, a user may communicate with one or more agents on an AI platform. During the interaction, the one or more agents may accumulate and store contextual information associated with the user. The contextual information associated with the user may improve performance of the AI platform. For example, the AI platform may provide more accurate or personalized outputs to the user based on the contextual information.

However, storing the contextual information associated with the user may introduce security vulnerabilities. Specifically, when information associated with the user is a part of global context information used by multiple agents of the AI platform, the information may inform outputs of agents that the user is not in communication with. That is, the user's information may be indirectly or directly revealed to another user by being a part of the global context information.

To protect user information, an AI platform may implement replicated agents. For example, when a user is to share sensitive information, the AI platform may create a replica agent that the user can share the sensitive information with. The replica agent may store the contextual information associated with the user as local context information separate from the global context information available to other agents of the AI platform. That is, the sensitive information shared with the replica agent may be isolated from the global context information such that the sensitive information is not used to generate responses to other users in communication with other agents of the AI platform. After the communication is complete, the replica agent may self-terminate, thereby destroying the local context information including the user's sensitive information.

In some examples, a system may evaluate communications to determine whether a replica instance is to be generated. In some examples, such determinations may be made based on a learning process based on prior communications that may indicate examples of sensitive data that would involve the use of a replica agent. In some examples, replica agents may be generated based on one or more replication policies that may indicate criteria that, when satisfied, may indicate that a replica agent is to be employed. In some examples, records relating to sensitive information may be encrypted or encoded using neural embeddings that may only be accessible by the replica agent and that may be destroyed after communications are concluded (e.g., in association with the destruction of the replica agent itself). In some examples, time stamping may be employed to record when a replica is created, and the replica may only be permitted to operate for a given amount of time measured from the creation time stamp (e.g., the replica may expire after a given amount of time).

Aspects of the disclosure are initially described in the context of an environment supporting an on-demand database service. Aspects of the disclosure are then described with reference to a system and a process flow. Aspects of the disclosure are further illustrated by and described with reference to apparatus diagrams, system diagrams, and flowcharts that relate to agent replication with local context information and data segmentation.

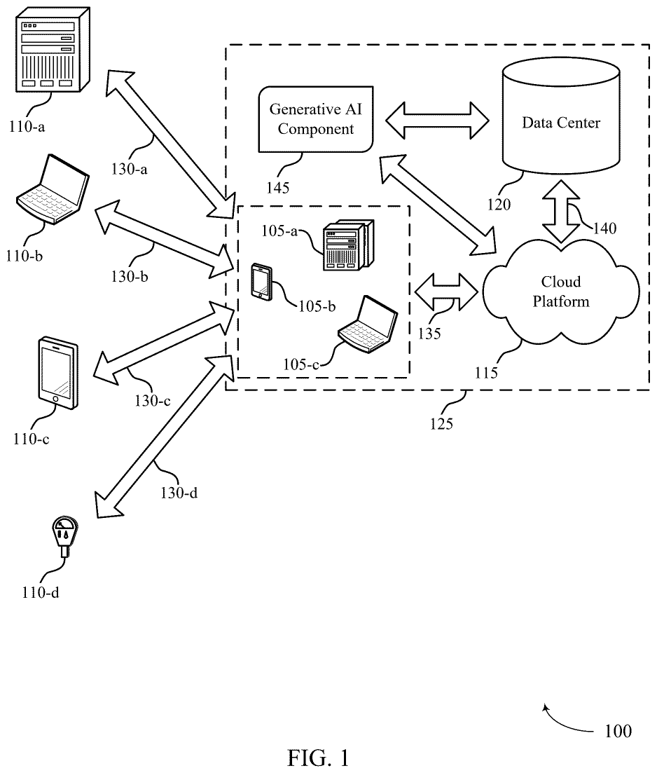

FIG. 1 illustrates an example of a system 100 for cloud computing that supports agent replication with local context information and data segmentation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including-but not limited to-client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, a cloud platform 115 may employ the use of one or more agents that may operate in conjunction with the generative AI component 145. The cloud platform 115 may determine (e.g., based on communications with a cloud client 105 via the agent) that the cloud client 105 is to communicate sensitive information. As a result, the cloud platform 115 may generate a replica agent that may be used for subsequent communications with the cloud client 105 that may involve the sensitive information. After such communications are concluded, the replica agent and records involving the sensitive information may be destroyed.

Other approaches involving AI agents may be subject to inherent technical challenges in regarding the secure handling and segregation of sensitive information during multi-agent communications. For example, management of sensitive information access across distributed agent networks may be difficult or prone to errors or leaks. Further, preservation of data privacy in shared-context environments involving multiple agents may be difficult, and sensitive information may be made available to agents or users that should not have access to such information. Further, handling of sensitive communications in situations in which multiple agents operate within the same platform infrastructure may be difficult, as sensitive communications or information may be shared (e.g., directly or indirectly) with agents and or users not authorized to receive such information. Such challenges may be particularly significant in systems where global context information (e.g., non-sensitive data) must coexist with user-specific sensitive data. Further, other approaches may rely heavily on application-level enforcement mechanisms to manage contextual data segmentation, which may introduce potential vulnerabilities due to errors or inconsistencies in application logic. Further, other approaches may employ standard encryption or context segregation techniques in efforts to reduce data leakage, but such techniques may be less effective. Conventional agent replication approaches may lack stringent mechanisms to promote the secure termination of replicas, potentially leading to residual data persistence. Further, some existing systems may use static or manual rules to determine the sensitivity of a transaction. In some examples, other replication mechanisms may not optimize resource use effectively for high-volume or high-sensitivity transactions. In some examples, other replication techniques often lack robust lifecycle tracking, which can lead to vulnerabilities like extended data persistence. In some examples, other approaches may aim for compliance through add-on features, which may not be sufficient. In some examples, other approaches employing monolithic agent architectures can become resource intensive.

To reduce or eliminate such challenges, the subject matter described herein contemplates a comprehensive technical solution framework predicated on the instantiation of agent replicas that maintain bifurcated information architectures, including both global context information shared across the agent network and isolated local context information specific to individual users that may be received and processed only by replica agents that are to be destroyed after the interactions are concluded. The subject matter described herein further includes multiple security mechanisms, including neural network-based encryption of local context information (e.g., accessible only by the replica agent(s) created to handle the information and related processing), controlled embedding access protocols (e.g., limiting access to encrypted or embedded information to only the replica agent(s) created to handle the information and related processing), selective component activation methodologies (e.g., only activating or utilizing portions or elements of replica agents that are involved with the interactions involving the sensitive information and processing of the sensitive information), and temporal instance management (e.g., time stamping at creation of the replica agents and time limits on operation of the replica agents, after which the replicas are destroyed). The framework implements sophisticated security controls through programmatic destruction of replica instances, secure logging protocols that exclude sensitive data, and systematic overwriting of residual information to promote complete data sanitization. Further, the subject matter described herein may shift the responsibility from the application level to the infrastructure level by dynamically spawning self-contained replicas inherently isolating data for each transaction.

In some examples, the subject matter described herein may incorporate self-terminating replicas that securely erase all local context information through a data wiping module immediately after use, ensuring zero leakage. In some examples, the subject matter described herein may employ a replication policy engine that dynamically evaluates transaction sensitivity based on data type, compliance considerations, and user-defined replication policies. This may promote both efficient and precise replication decisions. In some examples, the subject matter described herein may use real-time telemetry and event analytics to adapt the behavior and resource allocation of replicas dynamically, enhancing performance and reducing latency. In some examples, the subject matter described herein may introduce a time-stamping mechanism to enforce strict, time-bound operations for replicas, promoting secure data handling and termination within a timeframe. In some examples, the subject matter described herein is designed from the ground up to meet compliance considerations such as General Data Protection Regulation (GDPR) and the Health Insurance Portability and Accountability Act (HIPAA). The use of secure logging, metadata-level traceability, and contextual data self-destruction may ensure that all actions adhere to regulatory standards. In some examples, the subject matter described herein may employ modular execution where only some components of a replica are instantiated. This may reduce the attack surface, improve resource utilization, and support scalability for high transaction volumes.

For example, a user may interact with an agent and request information or operations to be performed. The system may, in the course of interactions with the user, determine that the interactions may include or be associated with sensitive information. In response, the system may generate a replica agent that may perform the interactions with the user that involve the sensitive data. After conclusion of the operations, the replica agent and one or more records associated with the sensitive information may be destroyed. In some examples, the user may be notified that a replica agent is being used and that the replica and the sensitive information will be destroyed after the interactions. Additionally, or alternatively, the user may not be aware that a replica agent is being used.

It should be appreciated by a person skilled in the art that one or more aspects of the disclosure may be implemented in a system 100 to additionally, or alternatively, solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

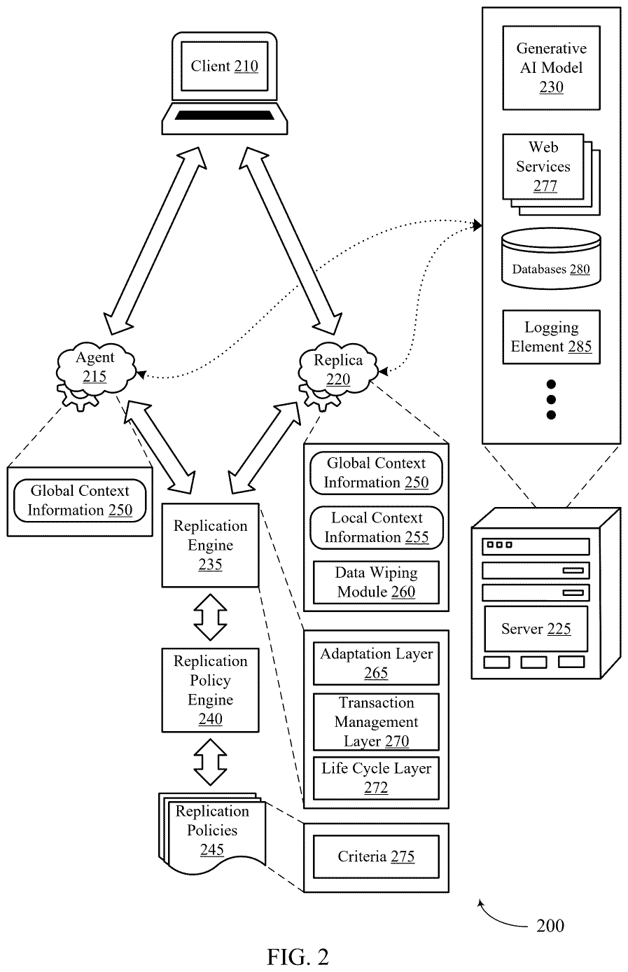

FIG. 2 shows an example of a system 200 that supports agent replication with local context information and data segmentation in accordance with examples as disclosed herein.

The system 200 may include a client 210, a server 225, and a generative AI model 230. The server 225 may represent a single server or processing entity, multiple servers or processing entities, a complete processing system, or any other entity or entities capable of performing the operations described herein. The generative AI model 230 may be included as part of or otherwise associated with the server 225 or may operate independently of the server 225. The generative AI model 230 may represent a single generative AI model or multiple generative AI models.

For example, the system 200 may include one or more agents 215, which are supported by the generative AI model 230 that may handle interactions and transactions with the client 210. A replication engine 235 may be integrated into the system 200. The replication engine 235 may dynamically spawn self-replicating replicas 220 based on evaluations of one or more replication policies 245 (e.g., the criteria 275 included or indicated therein) and may introduce increased data isolation and security, learning-based decision-making (e.g., through the adaptation layer), and dynamic lifecycle management (e.g., through the life cycle layer 272). In some examples, the replication policy engine 240 may be a decision-making module that evaluates transaction sensitivity and determines (e.g., based on interactions with the client 210, the one or more replication policies 245, any other information described herein, or any combination thereof) whether the agent 215 should be replicated to create the replica 220.

As described herein, other approaches to AI agents do not sufficiently account for security of confidential or sensitive information, allowing leakage to other agents or users and other security gaps that may be problematic. The subject matter described herein may introduce self-replicating replicas 220 with neural context encapsulation and event-driven improvements, enforcing contextual data segmentation at the infrastructure level. Unlike existing solutions, this approach may leverage advanced neural techniques for security and compliance. Such integration of neural context encapsulation, temporal integrity layers, and event-driven improvements distinguish the subject matter described herein from traditional replication mechanisms and address the problems present in other approaches.

In some examples, the subject matter described herein may be applicable across various scenarios and implementations that involve secure handling of sensitive information (e.g., the local context information 255), such as finance, healthcare, and client service. By providing a scalable and resource-efficient mechanism for data segmentation, the subject matter described herein may meet the practical needs of enterprises operating under stringent compliance frameworks like GDPR and HIPAA, among others. Further, the subject matter described herein may provide a robust and scalable solution that discourages or prevents data leakage through neural context encapsulation and secure isolation mechanisms. It may further improve resource utilization through adaptive replication mechanisms and promote compliance with data security standards by securely erasing contextual embeddings post-transaction.

In some examples, the replication engine 235 may include one or more features to promote secure and efficient transaction handling. For example, the replication engine 235 may include a self-adaptive replication mechanism, with which replicas 220 are dynamically customized based on the transaction type, the content or characteristics of interactions with the client, any other information described herein, or any combination thereof.

In some examples, the replication engine may adapt one or more processing environments to reduce resource utilization and improve performance for the specific context. In some examples, the replication engine 235 may employ neural context encryption to encapsulate the local context information 255 into encrypted, transaction-specific embeddings. These embeddings may be decipherable only within the specific replica 220, promoting contextual isolation.

In some examples, the life cycle layer 272 may be employed to track the lifecycle of each replica 220, promoting precise time-bound operations. the life cycle layer 272 may discourage residual data persistence by enforcing strict lifecycle termination policies. For example, a time stamp may be created in response to creation of the replica 220, and the replica may expire (e.g., be automatically destroyed) after a period of time has passed since the creation of the replica 220 (e.g., measured relative to the time stamp).

In some examples, the replication engine 235 may employ event-driven instance improvement to fine-tune the behavior of each replica 220, reducing latency and resource consumption for high-sensitivity transactions. In some examples, the replication engine 235, the replication policy engine 240, or both, may employ policy-driven modular execution, in which transactions are modularized, and only some components of the replica 220 may be instantiated and others may not be instantiated, reducing the possible attack surface and promoting focused execution, reduced overhead, and increased efficiency.

In some examples, the replica 220 or any other element of the system 200 may include a data wiping module 260 that may be a mechanism to promote secure erasure or destruction of some or all local context information 255 accumulated by a replica 220. In some examples, the transaction management layer 270 may coordinates transaction workflows, including the creation, execution, and termination of replicas 220.

In some examples, during a transaction initialization stage in which an interaction or transaction request is initiated, the replication policy engine 240 may evaluate the sensitivity of the interactions or transactions. The criteria 275 for sensitivity evaluation may include the type of data being accessed, compliance considerations, user-defined replication policies 245, any other information described herein, or any combination thereof.

In some examples, during a replica spawning stage, if the replication policy engine 240 determines the transaction is sensitive, the replication engine 235 may spawn a new replica 220. This replica 220 may be encapsulated with secure neural embeddings to discourage cross-transaction data contamination. Further, the replication engine 235 may adapt dynamically to the transaction requirements using self-adaptive replication mechanisms and may encode local context information 255 into encrypted neural embeddings.

In some examples, during a transaction execution stage, the replica 220 may perform the transaction, interacting with databases 280, web services 277, the generative AI model 230, one or more other elements of the system 200, one or more external resources, or any combination thereof, to support the interactions of the agent 215, the replica 220, one or more other agents, or any combination thereof, with the client 210. local context information 255 accumulated during the transaction may remain confined to the isolated instance (e.g., the replica 220) and may exist only as encapsulated neural embeddings that are only accessible by the replica 220.

In some examples, during a self-termination and data wiping stage, in response to completion of the transaction, the replica 220 may self-terminate after securely encrypting and destroying the contextual embeddings of the local context information 255 (e.g., which may be performed by or through the data wiping module 260). The data wiping module 260 may securely overwrite residual data in transient storage or memory.

In some examples, the system may perform (e.g., using the logging element 285) one or more logging or auditing operations. For example, all actions performed by the replica 220, including spawning, execution, and termination, may be logged in a secure logging mechanism integrated into the infrastructure. This log may maintain metadata-level traceability without storing the local context information 255, promoting transparency and compliance.

In some examples, the system 200 (e.g., or one or more elements thereof) may perform neural context encapsulation operations, in which local context information 255 is transformed into neural embeddings that are isolated to the replica 220 and self-destruct after use. In some examples, the life cycle layer 272 may include a time-stamping mechanism that promotes precise lifecycle tracking and enforces time-bound operation for all replicas 220. In some examples, self-adaptive improvements may be used (e.g., in connection with the adaptation layer 265 or one or more other portions of the system 200), in which instances adapt dynamically to transaction complexity, improving performance while minimizing resource use. In some examples, the system 200 may employ event-driven execution may be used, in which real-time telemetry enables dynamic adjustments to replica 220 behavior for transaction efficiency.

By encapsulating local context information 255 in neural embeddings and enforcing strict data isolation, the system 200 may eliminate potential vulnerabilities associated with traditional replication techniques. Secure logging and metadata-level traceability may promote that the system adheres to regulatory considerations. Adaptive replication mechanisms may promote minimal resource utilization without compromising on transaction isolation. The architecture may handle high transaction volumes dynamically by leveraging event-driven instance spawning.

In some examples, the system may be used in customer service platforms to promote secure handling of sensitive client 210 interactions, such as financial queries or healthcare inquiries. It may provide contextual segmentation for workflows involving sensitive information (e.g., the local context information 255) in enterprise solutions. It may also address compliance considerations in sectors like finance, healthcare, and legal web services in regulated industries.

In some examples, the system 200 may introduce neural embeddings to encapsulate local context information 255. These embeddings may be transaction-specific and self-destruct after the transaction is completed, ensuring a higher level of data security and minimizing residual exposure.

A brief example may be illustrative. For example, the system 200 may perform initial communications with the client 210 through the agent 215 (or multiple such agents 215) selected from a pool of agents of the system 200. The agent 215 may have access to global context information 250 that is accessible by all agents in the AI platform. Such global context information 250 may include information that is not sensitive or subject to security considerations.

In the course of interactions, the agent 215 may receive a query from the client 210. The system 200 may determine that the query implicates, indicates, or includes sensitive information, such as the local context information 255, which may be subject to one or more security measures or considerations (e.g., as expressed in one or more replication policies 245). The replication engine 235 may generate the replica 220, which may be a replica of the agent 215, and, as such, may include or have access to the global context information 250.

Further, the replica 220 may further include or have access to the local context information 255 (e.g., sensitive information) to continue the interactions with the client 210 that involves or implicates the local context information 255.

For example, the agent 215 may already possess or may be provided with the global context information 250 in response to creation of the agent 215. During the interactions with client 210, the agent 215 may also accumulate some local context information 255 incrementally (e.g., which may be client-or transaction-specific). However, as per the replication policies 245, such local context information 255 may not be categorized as sensitive and no replication is done. However, after some N quantity of interactions with the client 210, the transaction or information indicated therein may get recategorized as sensitive and a replica 220 may be spawned. In that scenario, the global context information 250 possessed by the agent may be mapped, copied, or referred to the replica 220. Additionally, or alternatively, the replica 220 may also receive the local context information 255 that was accumulated by the agent 215 up until the sensitive categorization was performed. Such transferred local context information 255 may also be removed from or made inaccessible to the agent 215. As a result, all of the local context information 255 pertaining to the transaction with the client 210 will reside only in replica 220 subsequent to the replication.

In some examples, the replication policy engine 240 may be used to generate or reference one or more replication policies 245 upon which one or more criteria 275 that, when satisfied, may indicate that the replica 220 is to be generated.

In some examples, the replication engine 235 may be used to generate the replica 220. The replication engine 235 may include an adaptation layer 265 that may customize or modify the replica 220 based on interaction or communication characteristics (e.g., activating functions or features that are indicated in the interactions or communications and not activating functions or features not implicated). Further, the transaction management layer 270 may be used to coordinate transaction workflows, including the creation, execution, and termination of agent instances.

The replica 220 may perform additional communications or interactions with the client 210 (e.g., including operations or interactions with one or more other agents to carry out operations to support the interactions with the client 210). In the course of the additional communications or interactions with the client 210, the replica 220 may include or have access to the global context information 250 and the local context information 255, either or both of which may be employed to respond to queries and perform operations, communications, or other interactions.

After completing these additional communications or interactions, the system 200 may destroy the replica 220, the local context information 255, other information indicating or associated with the local context information 255, or any combination thereof. In some examples, the data wiping module 260 of the replica 220 may be used to wipe such information or data.

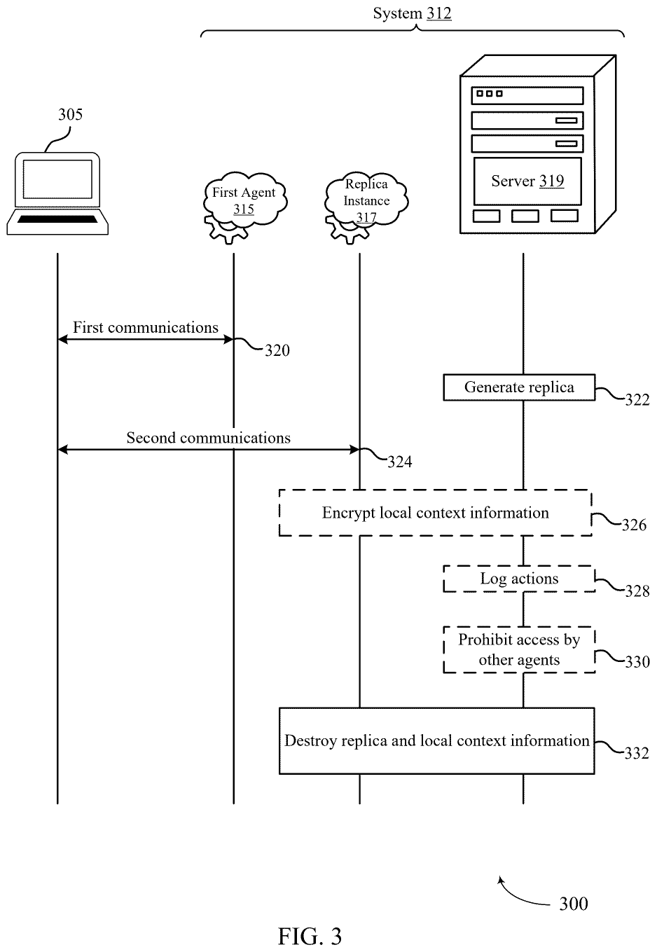

FIG. 3 shows an example of a process flow 300 that supports agent replication with local context information and data segmentation in accordance with examples as disclosed herein. The process flow 300 may implement various aspects of the present disclosure described herein. The elements described in the process flow 300 (e.g., the client 305, the first agent 315, the replica instance 317, the server 319, and the system 312) may be examples of similarly named elements described herein. In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, first communications may occur with a first user via one or more first agents 315 of a plurality of agents of the artificial intelligence (AI) platform. The one or more first agents 315 may have global context information accessible by the plurality of agents of the AI platform. In some examples, the system may obtain the global context information based on the first communications. In some examples, the first communications may include multiple subtransactions or subinteractions. For example, the first agent 315 may accumulate some local context information during such subtransactions or subinteractions, which may be encrypted and transferred to the replica instance 317 at a later time (e.g., after determining that a transaction or interaction (or subtransactions or subinteractions) are categorized as sensitive based on one or more replication policies.

At 322, the server 319 may generate a replica instance 317 of at least one agent of the plurality of agents of the AI platform based on receiving a first query from the first user during the first communications. The system may generate the replica instance 317 of the at least one agent based on a classification of at least a portion of the first communications or at least a portion of the global context information as sensitive information. The classification may be based on one or more previous user interactions of one or more agents of the plurality of agents. Additionally, the system may generate the replica instance 317 based on a replication policy that indicates one or more criteria, where one or more characteristics of the first communications satisfy the one or more criteria. The one or more criteria may include a match between one or more elements of the first communications with one or more conversation elements previously identified as sensitive. Furthermore, the system may activate a subset of components of a plurality of components associated with the replica instance 317, where selection of the subset of components is based on the first communications.

At 324, the replica instance 317 may perform second communications with the first user via one or more second agents of the plurality of agents of the AI platform. The one or more second agents may include the replica instance 317 of the at least one agent, which contains the global context information and local context information specific to the first user. In some examples, the system may obtain the global context information based on the first communications, the second communications, or both.

At 326, the replica instance 317 or the server 319 may encrypt the local context information with one or more neural networks to generate a plurality of embeddings associated with the second communications, where access to the plurality of embeddings is limited to the replica instance 317.

At 328, the server 319 may log actions performed by the replica instance 317 to generate one or more logs, where the one or more logs exclude the local context information.

At 330, the server 319 may prohibit access by agents other than the replica instance 317 to the local context information.

At 332, the server 319 may destroy the replica instance 317 of the at least one agent and the local context information specific to the first user after the second communications. The server 319 may also destroy the plurality of embeddings in accordance with destroying the replica instance 317 and may destroy the replica instance 317 based on the expiration of a timer associated with the replica instance 317. In some examples, the replica instance 317 or the server 319 may overwrite one or more residual portions of the local context information in accordance with destroying the replica instance 317.

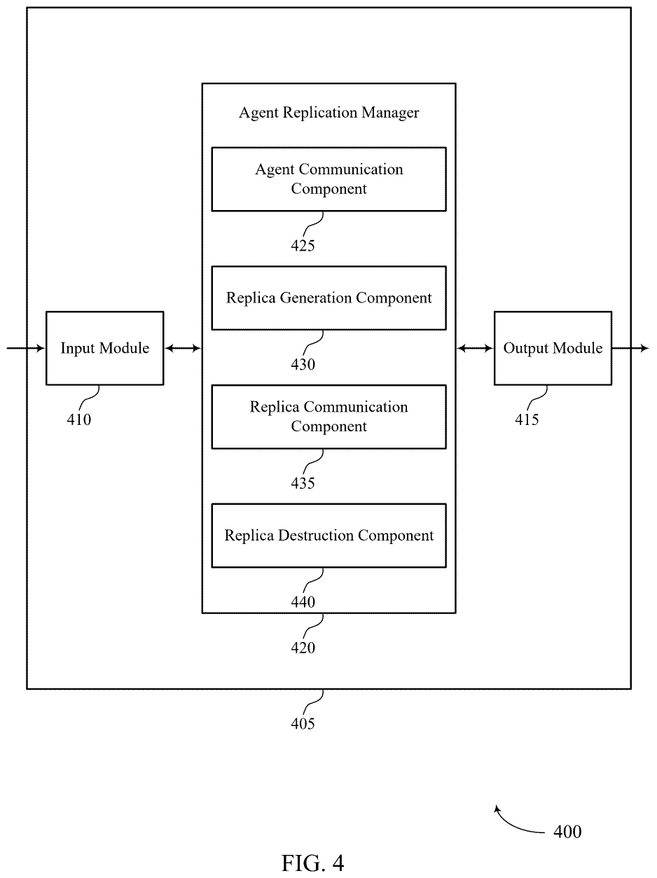

FIG. 4 shows a block diagram 400 of a device 405 that supports agent replication with local context information and data segmentation in accordance with examples as disclosed herein. The device 405 may include an input module 410, an output module 415, and an agent replication manager 420. The device 405, or one or more components of the device 405 (e.g., the input module 410, the output module 415, the agent replication manager 420), may include at least one processor, which may be coupled with at least one memory, to support the described techniques. Each of these components may be in communication with one another (e.g., via one or more buses).

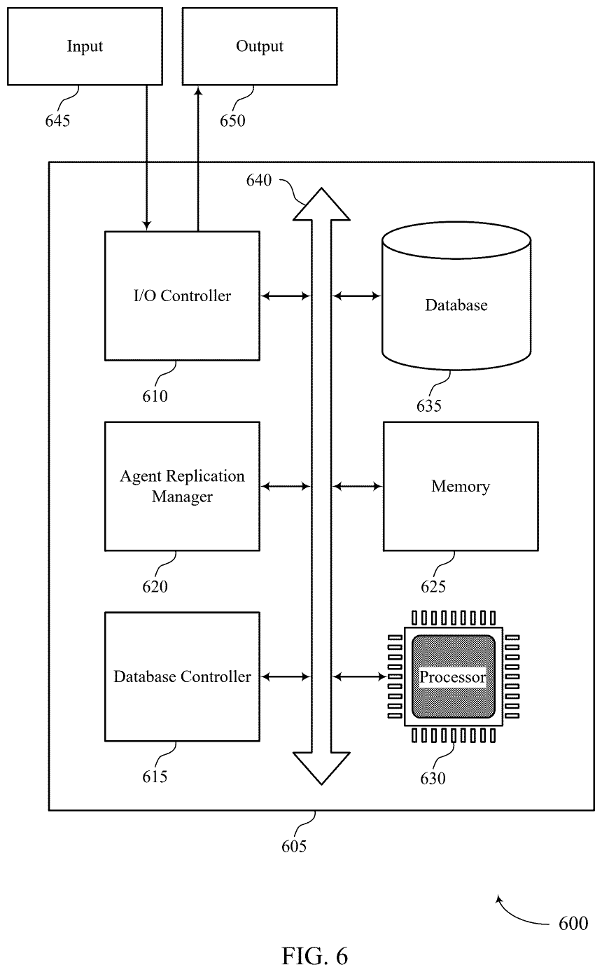

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the agent replication manager 420 to support agent replication with local context information and data segmentation. In some cases, the input module 410 may be a component of an input/output (I/O) controller 610 as described with reference to FIG. 6.

The output module 415 may manage output signals for the device 405. For example, the output module 415 may receive signals from other components of the device 405, such as the agent replication manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the agent replication manager 420 may include an agent communication component 425, a replica generation component 430, a replica communication component 435, a replica destruction component 440, or any combination thereof. In some examples, the agent replication manager 420, or various components thereof, may be configured to perform various operations (e.g., receiving, monitoring, transmitting) using or otherwise in cooperation with the input module 410, the output module 415, or both. For example, the agent replication manager 420 may receive information from the input module 410, send information to the output module 415, or be integrated in combination with the input module 410, the output module 415, or both to receive information, transmit information, or perform various other operations as described herein.

The agent replication manager 420 may support data processing in accordance with examples as disclosed herein. The agent communication component 425 may be configured to support performing first communications with a first user via one or more first agents of a set of multiple agents of the AI platform, where the one or more first agents have global context information accessible by the set of multiple agents of the AI platform. The replica generation component 430 may be configured to support generating a replica instance of at least one agent of the set of multiple agents of the AI platform based on receiving a first query from the first user during the first communications. The replica communication component 435 may be configured to support performing second communications with the first user via one or more second agents of the set of multiple agents of the AI platform, the one or more second agents including the replica instance of the at least one agent, where the replica instance of the at least one agent has the global context information and local context information specific to the first user. The replica destruction component 440 may be configured to support destroying, after the second communications, the replica instance of the at least one agent and the local context information specific to the first user.

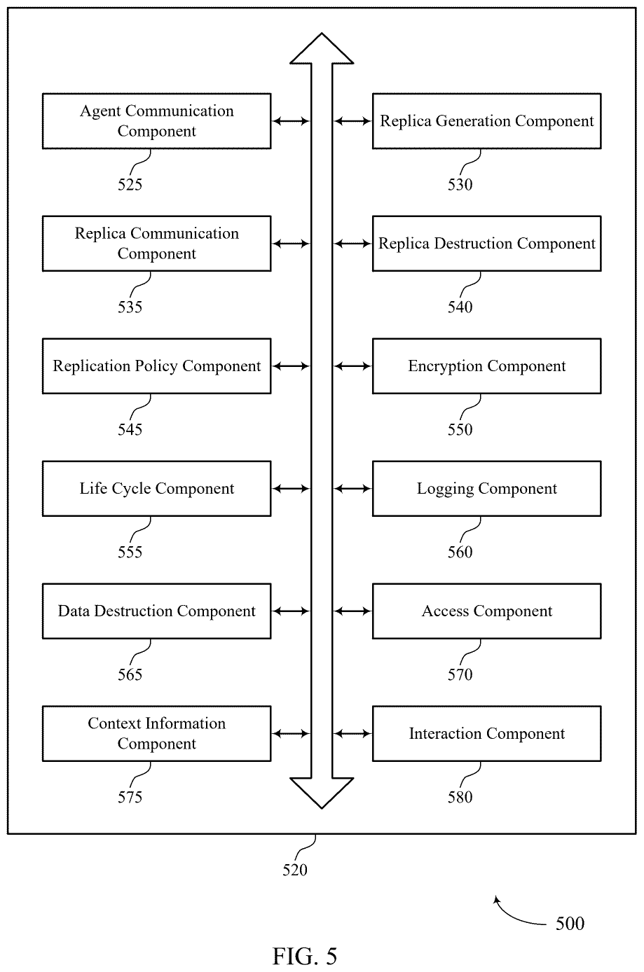

FIG. 5 shows a block diagram 500 of an agent replication manager 520 that supports agent replication with local context information and data segmentation in accordance with examples as disclosed herein. The agent replication manager 520 may be an example of aspects of an agent replication manager or an agent replication manager 420, or both, as described herein. The agent replication manager 520, or various components thereof, may be an example of means for performing (e.g., to cause the agent replication manager 520 to perform) various aspects of agent replication with local context information and data segmentation as described herein. For example, the agent replication manager 520 may include an agent communication component 525, a replica generation component 530, a replica communication component 535, a replica destruction component 540, a replication policy component 545, an encryption component 550, a life cycle component 555, a logging component 560, a data destruction component 565, an access component 570, a context information component 575, an interaction component 580, or any combination thereof. Each of these components, or components of subcomponents thereof (e.g., one or more processors, one or more memories), may communicate, directly or indirectly, with one another (e.g., via one or more buses).

The agent replication manager 520 may support data processing in accordance with examples as disclosed herein. The agent communication component 525 may be configured to support performing first communications with a first user via one or more first agents of a set of multiple agents of the AI platform, where the one or more first agents have global context information accessible by the set of multiple agents of the AI platform. The replica generation component 530 may be configured to support generating a replica instance of at least one agent of the set of multiple agents of the AI platform based on receiving a first query from the first user during the first communications. The replica communication component 535 may be configured to support performing second communications with the first user via one or more second agents of the set of multiple agents of the AI platform, the one or more second agents including the replica instance of the at least one agent, where the replica instance of the at least one agent has the global context information and local context information specific to the first user. The replica destruction component 540 may be configured to support destroying, after the second communications, the replica instance of the at least one agent and the local context information specific to the first user.

In some examples, the replica generation component 530 may be configured to support generating the replica instance of the at least one agent of the set of multiple agents based on a classification of at least a portion of the first communications or at least a portion of the global context information as sensitive information.

In some examples, the classification is based on one or more previous user interactions of one or more agents of the set of multiple agents.

In some examples, the replication policy component 545 may be configured to support generating the replica instance based on the first communications and one or more replication policies that indicate one or more criteria, where one or more characteristics of the first communications satisfy the one or more criteria.

In some examples, the one or more criteria include a match between one or more elements of the first communications with one or more conversation elements previously identified as sensitive.

In some examples, the encryption component 550 may be configured to support encrypting the local context information with one or more neural networks to generate a set of multiple embeddings associated with the second communications, where access to the set of multiple embeddings is limited to the replica instance. Further, in some examples, the encryption component 550 may be configured to support decryption of encrypted information. For example, information initially obtained by a first agent that is subsequently deemed to be sensitive, encrypted, and transferred to a replica instance, at which point the information may be decrypted by the encryption component 550).

In some examples, the replica destruction component 540 may be configured to support destroying, in accordance with destroying the replica instance, the set of multiple embeddings.

In some examples, the replica generation component 530 may be configured to support activating a subset of components of a set of multiple components associated with the replica instance, where selection of the subset of components is based on the first communications.

In some examples, the life cycle component 555 may be configured to support creating, based on generating the replica instance, a time stamp associated with the replica instance that indicates a first point in time associated with generation of the replica instance. In some examples, the life cycle component 555 may be configured to support destroying the replica instance based on an expiration of a timer that is measured relative to the first point in time and that is associated with the replica instance.

In some examples, the logging component 560 may be configured to support logging actions performed by the replica instance to generate one or more logs, where the one or more logs exclude the local context information.

In some examples, the data destruction component 565 may be configured to support overwriting, in accordance with destroying the replica instance, one or more residual portions of the local context information.

In some examples, the access component 570 may be configured to support prohibiting access, by agents other than the replica instance, to the local context information.

In some examples, the context information component 575 may be configured to support obtaining the global context information based on the first communications, the second communications, or both. In some examples, the context information component 575 may be configured to support obtaining the local context information based on the first communications, the second communications, or both.

FIG. 6 shows a diagram of a system 600 including a device 605 that supports agent replication with local context information and data segmentation in accordance with examples as disclosed herein. The device 605 may be an example of or include components of a device 405 as described herein. The device 605 may include components for bi-directional data communications including components for transmitting and receiving communications, such as an agent replication manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting agent replication with local context information and data segmentation). The processor 630 may be an example of a single processor or multiple processors. For example, the device 605 may include one or more processors 630.

The agent replication manager 620 may support data processing in accordance with examples as disclosed herein. For example, the agent replication manager 620 may be configured to support performing first communications with a first user via one or more first agents of a set of multiple agents of the AI platform, where the one or more first agents have global context information accessible by the set of multiple agents of the AI platform. The agent replication manager 620 may be configured to support generating a replica instance of at least one agent of the set of multiple agents of the AI platform based on receiving a first query from the first user during the first communications. The agent replication manager 620 may be configured to support performing second communications with the first user via one or more second agents of the set of multiple agents of the AI platform, the one or more second agents including the replica instance of the at least one agent, where the replica instance of the at least one agent has the global context information and local context information specific to the first user. The agent replication manager 620 may be configured to support destroying, after the second communications, the replica instance of the at least one agent and the local context information specific to the first user.

By including or configuring the agent replication manager 620 in accordance with examples as described herein, the device 605 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

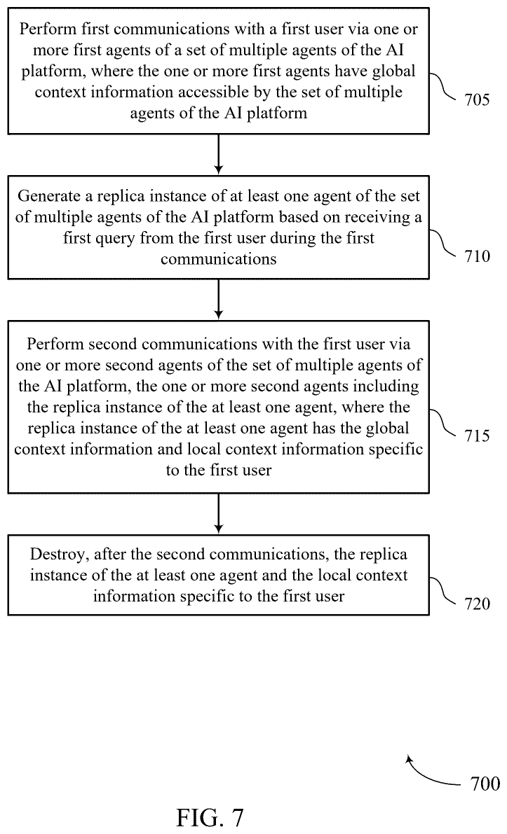

FIG. 7 shows a flowchart illustrating a method 700 that supports agent replication with local context information and data segmentation in accordance with examples as disclosed herein. The operations of the method 700 may be implemented by an application server or its components as described herein. For example, the operations of the method 700 may be performed by an application server as described with reference to FIGS. 1 through 6. In some examples, an application server may execute a set of instructions to control the functional elements of the application server to perform the described functions.

Additionally, or alternatively, the application server may perform aspects of the described functions using special-purpose hardware.

At 705, the method may include performing first communications with a first user via one or more first agents of a set of multiple agents of the AI platform, where the one or more first agents have global context information accessible by the set of multiple agents of the AI platform. The operations of 705 may be performed in accordance with examples as disclosed herein. In some examples, aspects of the operations of 705 may be performed by an agent communication component 525.

At 710, the method may include generating a replica instance of at least one agent of the set of multiple agents of the AI platform based on receiving a first query from the first user during the first communications. The operations of 710 may be performed in accordance with examples as disclosed herein. In some examples, aspects of the operations of 710 may be performed by a replica generation component 530.

At 715, the method may include performing second communications with the first user via one or more second agents of the set of multiple agents of the AI platform, the one or more second agents including the replica instance of the at least one agent, where the replica instance of the at least one agent has the global context information and local context information specific to the first user. The operations of 715 may be performed in accordance with examples as disclosed herein. In some examples, aspects of the operations of 715 may be performed by a replica communication component 535.

At 720, the method may include destroying, after the second communications, the replica instance of the at least one agent and the local context information specific to the first user. The operations of 720 may be performed in accordance with examples as disclosed herein. In some examples, aspects of the operations of 720 may be performed by a replica destruction component 540.

A method for data processing by an artificial intelligence (AI) platform is described. The method may include performing first communications with a first user via one or more first agents of a set of multiple agents of the AI platform, where the one or more first agents have global context information accessible by the set of multiple agents of the AI platform, generating a replica instance of at least one agent of the set of multiple agents of the AI platform based on receiving a first query from the first user during the first communications, performing second communications with the first user via one or more second agents of the set of multiple agents of the AI platform, the one or more second agents including the replica instance of the at least one agent, where the replica instance of the at least one agent has the global context information and local context information specific to the first user, and destroying, after the second communications, the replica instance of the at least one agent and the local context information specific to the first user.

An artificial intelligence (AI) platform for data processing is described. The artificial intelligence (AI) platform may include one or more memories storing processor executable code, and one or more processors coupled with the one or more memories. The one or more processors may individually or collectively be operable to execute the code to cause the artificial intelligence (AI) platform to perform first communications with a first user via one or more first agents of a set of multiple agents of the AI platform, where the one or more first agents have global context information accessible by the set of multiple agents of the AI platform, generate a replica instance of at least one agent of the set of multiple agents of the AI platform based on receiving a first query from the first user during the first communications, perform second communications with the first user via one or more second agents of the set of multiple agents of the AI platform, the one or more second agents including the replica instance of the at least one agent, where the replica instance of the at least one agent has the global context information and local context information specific to the first user, and destroy, after the second communications, the replica instance of the at least one agent and the local context information specific to the first user.

Another artificial intelligence (AI) platform for data processing is described. The artificial intelligence (AI) platform may include means for performing first communications with a first user via one or more first agents of a set of multiple agents of the AI platform, where the one or more first agents have global context information accessible by the set of multiple agents of the AI platform, means for generating a replica instance of at least one agent of the set of multiple agents of the AI platform based on receiving a first query from the first user during the first communications, means for performing second communications with the first user via one or more second agents of the set of multiple agents of the AI platform, the one or more second agents including the replica instance of the at least one agent, where the replica instance of the at least one agent has the global context information and local context information specific to the first user, and means for destroying, after the second communications, the replica instance of the at least one agent and the local context information specific to the first user.

A non-transitory computer-readable medium storing code for data processing is described. The code may include instructions executable by one or more processors to perform first communications with a first user via one or more first agents of a set of multiple agents of the AI platform, where the one or more first agents have global context information accessible by the set of multiple agents of the AI platform, generate a replica instance of at least one agent of the set of multiple agents of the AI platform based on receiving a first query from the first user during the first communications, perform second communications with the first user via one or more second agents of the set of multiple agents of the AI platform, the one or more second agents including the replica instance of the at least one agent, where the replica instance of the at least one agent has the global context information and local context information specific to the first user, and destroy, after the second communications, the replica instance of the at least one agent and the local context information specific to the first user.

Some examples of the method, artificial intelligences (AIs), and non-transitory computer-readable medium described herein may further include operations, features, means, or instructions for generating the replica instance of the at least one agent of the set of multiple agents based on a classification of at least a portion of the first communications or at least a portion of the global context information as sensitive information.

In some examples of the method, artificial intelligences (Als), and non-transitory computer-readable medium described herein, the classification may be based on one or more previous user interactions of one or more agents of the set of multiple agents.

Some examples of the method, artificial intelligences (AIs), and non-transitory computer-readable medium described herein may further include operations, features, means, or instructions for generating the replica instance based on the first communications and one or more replication policies that indicate one or more criteria, where one or more characteristics of the first communications satisfy the one or more criteria.

In some examples of the method, artificial intelligences (Als), and non-transitory computer-readable medium described herein, the one or more criteria include a match between one or more elements of the first communications with one or more conversation elements previously identified as sensitive.

Some examples of the method, artificial intelligences (AIs), and non-transitory computer-readable medium described herein may further include operations, features, means, or instructions for encrypting the local context information with one or more neural networks to generate a set of multiple embeddings associated with the second communications, where access to the set of multiple embeddings may be limited to the replica instance.

Some examples of the method, artificial intelligences (AIs), and non-transitory computer-readable medium described herein may further include operations, features, means, or instructions for destroying, in accordance with destroying the replica instance, the set of multiple embeddings.

Some examples of the method, artificial intelligences (AIs), and non-transitory computer-readable medium described herein may further include operations, features, means, or instructions for activating a subset of components of a set of multiple components associated with the replica instance, where selection of the subset of components may be based on the first communications.

Some examples of the method, artificial intelligences (AIs), and non-transitory computer-readable medium described herein may further include operations, features, means, or instructions for creating, based on generating the replica instance, a time stamp associated with the replica instance that indicates a first point in time associated with generation of the replica instance and destroying the replica instance based on an expiration of a timer that may be measured relative to the first point in time and that may be associated with the replica instance.

Some examples of the method, artificial intelligences (AIs), and non-transitory computer-readable medium described herein may further include operations, features, means, or instructions for logging actions performed by the replica instance to generate one or more logs, where the one or more logs exclude the local context information.

Some examples of the method, artificial intelligences (AIs), and non-transitory computer-readable medium described herein may further include operations, features, means, or instructions for overwriting, in accordance with destroying the replica instance, one or more residual portions of the local context information.

Some examples of the method, artificial intelligences (AIs), and non-transitory computer-readable medium described herein may further include operations, features, means, or instructions for prohibiting access, by agents other than the replica instance, to the local context information.

Some examples of the method, artificial intelligences (AIs), and non-transitory computer-readable medium described herein may further include operations, features, means, or instructions for obtaining the global context information based on the first communications, the second communications, or both and obtaining the local context information based on the first communications, the second communications, or both.

The following provides an overview of aspects of the present disclosure:

Aspect 1: A method for data processing at an artificial intelligence (AI) platform, comprising: performing first communications with a first user via one or more first agents of a plurality of agents of the AI platform, wherein the one or more first agents have global context information accessible by the plurality of agents of the AI platform; generating a replica instance of at least one agent of the plurality of agents of the AI platform based at least in part on receiving a first query from the first user during the first communications; performing second communications with the first user via one or more second agents of the plurality of agents of the AI platform, the one or more second agents comprising the replica instance of the at least one agent, wherein the replica instance of the at least one agent has the global context information and local context information specific to the first user; and destroying, after the second communications, the replica instance of the at least one agent and the local context information specific to the first user.

Aspect 2: The method of aspect 1, further comprising: generating the replica instance of the at least one agent of the plurality of agents based at least in part on a classification of at least a portion of the first communications or at least a portion of the global context information as sensitive information.

Aspect 3: The method of aspect 2, wherein the classification is based at least in part on one or more previous user interactions of one or more agents of the plurality of agents.

Aspect 4: The method of any of aspects 1 through 3, further comprising: generating the replica instance based at least in part on the first communications and one or more replication policies that indicate one or more criteria, wherein one or more characteristics of the first communications satisfy the one or more criteria.

Aspect 5: The method of aspect 4, wherein the one or more criteria comprise a match between one or more elements of the first communications with one or more conversation elements previously identified as sensitive.

Aspect 6: The method of any of aspects 1 through 5, further comprising: encrypting the local context information with one or more neural networks to generate a plurality of embeddings associated with the second communications, wherein access to the plurality of embeddings is limited to the replica instance.

Aspect 7: The method of aspect 6, further comprising: destroying, in accordance with destroying the replica instance, the plurality of embeddings.

Aspect 8: The method of any of aspects 1 through 7, further comprising: activating a subset of components of a plurality of components associated with the replica instance, wherein selection of the subset of components is based at least in part on the first communications.

Aspect 9: The method of any of aspects 1 through 8, further comprising: creating, based at least in part on generating the replica instance, a time stamp associated with the replica instance that indicates a first point in time associated with generation of the replica instance; destroying the replica instance based at least in part on an expiration of a timer that is measured relative to the first point in time and that is associated with the replica instance.

Aspect 10: The method of any of aspects 1 through 9, further comprising: logging actions performed by the replica instance to generate one or more logs, wherein the one or more logs exclude the local context information.

Aspect 11: The method of any of aspects 1 through 10, further comprising: overwriting, in accordance with destroying the replica instance, one or more residual portions of the local context information.

Aspect 12: The method of any of aspects 1 through 11, further comprising: prohibiting access, by agents other than the replica instance, to the local context information.

Aspect 13: The method of any of aspects 1 through 12, further comprising: obtaining the global context information based at least in part on the first communications, the second communications, or both; and obtaining the local context information based at least in part on the first communications, the second communications, or both.

Aspect 14: An artificial intelligence (AI) platform for data processing, comprising one or more memories storing processor-executable code, and one or more processors coupled with the one or more memories and individually or collectively operable to execute the code to cause the artificial intelligence (AI) platform to perform a method of any of aspects 1 through 13.

Aspect 15: An artificial intelligence (AI) platform for data processing, comprising at least one means for performing a method of any of aspects 1 through 13.

Aspect 16: A non-transitory computer-readable medium storing code for data processing, the code comprising instructions executable by one or more processors to perform a method of any of aspects 1 through 13.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or Cor AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for data processing at an artificial intelligence (AI) platform, comprising:
performing first communications with a first user via one or more first agents of a plurality of agents of the AI platform, wherein the one or more first agents have global context information accessible by the plurality of agents of the AI platform;
generating a replica instance of at least one agent that communicated with the first user of the plurality of agents of the AI platform based at least in part on receiving a first query from the first user during the first communications;
performing second communications with the first user via one or more second agents of the plurality of agents of the AI platform, the one or more second agents comprising the replica instance of the at least one agent, wherein the replica instance of the at least one agent has the global context information and local context information specific to the first user; and
destroying, after the second communications, the replica instance of the at least one agent and the local context information specific to the first user.

2. The method of claim 1, further comprising:
generating the replica instance of the at least one agent of the plurality of agents based at least in part on a classification of at least a portion of the first communications or at least a portion of the global context information as sensitive information.

3. The method of claim 2, wherein the classification is based at least in part on one or more previous user interactions of one or more agents of the plurality of agents.

4. The method of claim 1, further comprising:
generating the replica instance based at least in part on the first communications and one or more replication policies that indicate one or more criteria, wherein one or more characteristics of the first communications satisfy the one or more criteria.

5. The method of claim 4, wherein the one or more criteria comprise a match between one or more elements of the first communications with one or more conversation elements previously identified as sensitive.

6. The method of claim 1, further comprising:
encrypting the local context information with one or more neural networks to generate a plurality of embeddings associated with the second communications, wherein access to the plurality of embeddings is limited to the replica instance.

7. The method of claim 6, further comprising:
destroying, in accordance with destroying the replica instance, the plurality of embeddings.

8. The method of claim 1, further comprising:
activating a subset of components of a plurality of components associated with the replica instance, wherein selection of the subset of components is based at least in part on the first communications.

9. The method of claim 1, further comprising:
creating, based at least in part on generating the replica instance, a time stamp associated with the replica instance that indicates a first point in time associated with generation of the replica instance; and
destroying the replica instance based at least in part on an expiration of a timer that is measured relative to the first point in time and that is associated with the replica instance.

10. The method of claim 1, further comprising:
logging actions performed by the replica instance to generate one or more logs, wherein the one or more logs exclude the local context information.

11. The method of claim 1, further comprising:
overwriting, in accordance with destroying the replica instance, one or more residual portions of the local context information.

12. The method of claim 1, further comprising:
prohibiting access, by agents other than the replica instance, to the local context information.

13. The method of claim 1, further comprising:
obtaining the global context information based at least in part on the first communications, the second communications, or both; and
obtaining the local context information based at least in part on the first communications, the second communications, or both.

14. An artificial intelligence (AI) platform for data processing, comprising:
one or more memories storing processor-executable code; and
one or more processors coupled with the one or more memories and individually or collectively operable to execute the code to cause the artificial intelligence (AI) platform to:
perform first communications with a first user via one or more first agents of a plurality of agents of the AI platform, wherein the one or more first agents have global context information accessible by the plurality of agents of the AI platform;
generate a replica instance of at least one agent that communicated with the first user of the plurality of agents of the AI platform based at least in part on receiving a first query from the first user during the first communications;
perform second communications with the first user via one or more second agents of the plurality of agents of the AI platform, the one or more second agents comprising the replica instance of the at least one agent, wherein the replica instance of the at least one agent has the global context information and local context information specific to the first user; and
destroy, after the second communications, the replica instance of the at least one agent and the local context information specific to the first user.

15. The artificial intelligence (AI) platform of claim 14, wherein the one or more processors are individually or collectively further operable to execute the code to cause the artificial intelligence (AI) platform to:
generate the replica instance of the at least one agent of the plurality of agents based at least in part on a classification of at least a portion of the first communications or at least a portion of the global context information as sensitive information.

16. The artificial intelligence (AI) platform of claim 15, wherein the classification is based at least in part on one or more previous user interactions of one or more agents of the plurality of agents.

17. The artificial intelligence (AI) platform of claim 14, wherein the one or more processors are individually or collectively further operable to execute the code to cause the artificial intelligence (AI) platform to:
generate the replica instance based at least in part on the first communications and one or more replication policies that indicate one or more criteria, wherein one or more characteristics of the first communications satisfy the one or more criteria.

18. The artificial intelligence (AI) platform of claim 17, wherein the one or more criteria comprise a match between one or more elements of the first communications with one or more conversation elements previously identified as sensitive.

19. The artificial intelligence (AI) platform of claim 14, wherein the one or more processors are individually or collectively further operable to execute the code to cause the artificial intelligence (AI) platform to:
encrypt the local context information with one or more neural networks to generate a plurality of embeddings associated with the second communications, wherein access to the plurality of embeddings is limited to the replica instance.

20. A non-transitory computer-readable medium comprising at least one of random-access memory, read-only memory, electrically erasable programmable read-only memory, compact disk read-only memory, or magnetic disk storage, the non-transitory computer-readable medium storing code for data processing, the code comprising instructions executable by one or more processors to:
perform first communications with a first user via one or more first agents of a plurality of agents of an artificial intelligence (AI) platform, wherein the one or more first agents have global context information accessible by the plurality of agents of the AI platform;
generate a replica instance of at least one agent that communicated with the first user of the plurality of agents of the AI platform based at least in part on receiving a first query from the first user during the first communications;
perform second communications with the first user via one or more second agents of the plurality of agents of the AI platform, the one or more second agents comprising the replica instance of the at least one agent, wherein the replica instance of the at least one agent has the global context information and local context information specific to the first user; and
destroy, after the second communications, the replica instance of the at least one agent and the local context information specific to the first user.
